(19) United States
(12) Patent Application Publication
(10) Pub. No.: US 2026/0039040 A1
(43) Pub. Date: Feb. 5, 2026

(54) CONNECTION TERMINAL

(71) Applicant: LG INNOTEK CO., LTD., Seoul (KR)

(72) Inventors: Ki Dong KIM, Seoul (KR); Byung Nam CHOI, Seoul (KR)

(73) Assignee: LG INNOTEK CO., LTD., Seoul (KR)

(21) Appl. No.: 18/997,329

(22) PCT Filed: Jul. 18, 2023
(86) PCT No.: PCT/KR2023/010237

§ 371 Date: Jan. 21, 2025

(30) Foreign Application Priority Data
Jul. 20, 2022 (KR) 10-2022-0089834

(51) Int. Cl. H01R 12/58; H01R 4/56

(52) U.S. Cl. CPC H01R 12/58; H01R 4/56

(57) ABSTRACT

A connection terminal according to one embodiment of the present invention comprises: a base; a plurality of first extension units extended from a lateral part of the base to the lower part thereof; a plurality of second extension units extended from a lateral part of the base to the lower part thereof; and a plurality of third extension units extended from a lateral part of the base to the upper part thereof.

### TECHNICAL FIELD

The teachings in accordance with exemplary and non-limiting embodiments of this invention relate generally to a connection terminal, and more particularly to a poka-yoke, an anti-rotation connection terminal and a power transmission device comprising the same.

### BACKGROUND ARTS

As the structure becomes more complex, such as converting the voltage of the battery or incorporating a DCDC converter or OBC (On Board Charger) that transmits battery power, there are more and more connections that flow a lot of current, such as power connection units, and the risk of misassembly increases as the number of connections that need to be assembled increases.

In addition, if the power connection unit is connected through a busbar and a lot of current flows, it must be connected firmly and accurately, especially when screwing, there is a problem that rotation occurs and tolerances occur.

### DETAILED DESCRIPTION OF THE INVENTION

### Technical Problems

The technical problems that the present invention seeks to solve are to provide a poka-yoke, an anti-rotation connection terminal and a power transmission device comprising the same.

### Technical Solution

A connection terminal according to one exemplary embodiment of the present invention to solve the aforementioned problems comprises: a base; a plurality of first extension units extended from a lateral part of the base to the lower part thereof; a plurality of second extension units extended from a lateral part of the base to the lower part thereof; and a plurality of third extension units extended from a lateral part of the base to the upper part thereof.

Preferably, but not necessarily, the base may be rectangular in shape, and the first extension unit may extend downwardly from a first lateral part of the base or a second lateral part facing the first lateral part.

Preferably, but not necessarily, the first extension unit may include a first lateral plate part extending downwardly from the first lateral part or the second lateral part; and a plurality of first protrusions extending downwardly from the first lateral plate part and spaced apart from each other.

Preferably, but not necessarily, the base may be rectangular in shape, and the second extension unit may extend downwardly from a third lateral part of the base or a fourth lateral part facing the third lateral part.

Preferably, but not necessarily, the second extension unit may include a second protrusion extending downwardly from the third lateral part or the fourth lateral part.

Preferably, but not necessarily, the third extension unit may include a plurality of third protrusions extending upwardly from the third lateral part or the fourth lateral part, and located on either side of the second protrusion.

Preferably, but not necessarily, the second protrusion may be one located in the center of the third lateral part or the fourth lateral part, and the third protrusion may be two in number located on either side of the one second protrusion.

Preferably, but not necessarily, a widthwise length of the second protrusion may be longer than a widthwise length of the third protrusion.

Preferably, but not necessarily, the base may include a screw connection unit having a hole formed in its center and a threaded body protruding upwardly through the hole.

Preferably, but not necessarily, the area of the upper surface of the base may vary depending on the current flowing through the connection terminals and the allowable current density.

In order to solve the above technical challenges, a power transmission device according to an exemplary embodiment of the present invention may comprise: a substrate; a housing covering the substrate but including a plurality of connection terminal regions in which a portion of the substrate is exposed and in which the connection terminal is disposed; and the connection terminal located in the connection terminal regions, wherein the plurality of connection terminal regions is formed with mutually differently shaped protrusions.

Preferably, but not necessarily, the plurality of connection terminal regions may each be matched and connected with a busbar corresponding to the protrusion.

Preferably, but not necessarily, the connection terminal region may comprise: a first lateral surface spaced inwardly from an edge of the one lateral part of the substrate; and a second lateral surface and a third lateral surface extending from both sides of the first lateral surface in the direction of the edge of the one lateral part of the substrate, wherein the substrate, the first lateral surface, the second lateral surface, and the third lateral surface form a first recess open in an upward direction of the substrate and an outward direction of the edge of the one lateral part of the substrate, and wherein the protrusion may protrude from at least one of the first lateral surface, the second lateral surface, and the third lateral surface.

Preferably, but not necessarily, in the first recess are located first connection terminals and second connection terminals, which are coupled to each other to form a (+) terminal and a (−) terminal, the connection terminal region comprising: a first protrusion protruding in the direction of the first connection terminal from a corner formed by the first lateral surface and the second lateral surface; a second protrusion protruding from the center of the first lateral surface in a direction between the first and second connection terminals; a third protrusion protruding towards the second connection terminals from a corner formed by the first lateral surface and the second lateral surface; and a fourth protrusion protruding from the third lateral surface towards the second connection terminals.

Preferably, but not necessarily, the first recess may include a third connection terminal and a fourth connection terminal, which are paired with each other to form a (+) terminal and a (−) terminal, and the connection terminal region may include: a fifth protrusion protruding from the first lateral surface towards the center of the third connection terminal; and a sixth protrusion protruding from the first lateral surface towards the fourth connection terminal, but biased towards the third lateral surface.

Preferably, but not necessarily, the connection terminal may be any of the connection terminals described above.

### Advantageous Effects

According to embodiments of the present invention, poka-yoke is possible by preventing misassembly of the busbars. Furthermore, standardized connection terminals can be used to connect the busbars, where the connection terminals can prevent the busbars from rotating, thereby increasing workability and reliability.

### BRIEF DESCRIPTION OF DRAWINGS

FIG. 1 is a perspective view of a connection terminal according to one exemplary embodiment of the present invention.

FIG. 2 is a plan view of a connection terminal according to an exemplary embodiment of the present invention.

FIG. 3 is a numerical example according to an exemplary embodiment of the present invention.

FIG. 4 is a diagram of a screw connection part incorporated into a connection terminal according to an exemplary embodiment of the present invention.

FIG. 5 is a perspective view of a connection terminal region of a power transmission device according to an exemplary embodiment of the present invention.

FIGS. 6 to 11 are drawings to illustrate respective configurations of a connection terminal region of a power transmission device according to an exemplary embodiment of the present invention.

FIG. 12 illustrates an example of a busbar being connected to the connection terminal region of a power transmission device according to an exemplary embodiment of the present invention.

FIGS. 13 to 18 are drawings to illustrate the connected relationship of a busbar to a connection terminal region of a power transmission device according to an exemplary embodiment of the present invention.

FIGS. 19 and 20 are drawings illustrating an assembly process of a power transmission device and a busbar according to an exemplary embodiment of the present invention.

### BEST MODE

Hereinafter, exemplary embodiments of the present invention will be described in detail with reference to the accompanying drawings.

However, the present invention is not limited to the given exemplary embodiments described, but may be implemented in a variety of different forms, and one or more of components among the exemplary embodiments may be optionally combined or substituted between embodiments within the scope of the present invention.

Furthermore, terms (including technical and scientific terms) used in the embodiments of the present invention, unless expressly specifically defined and described, are to be interpreted in the sense in which they would be understood by a person of ordinary skill in the art to which the present invention belongs, and commonly used terms, such as dictionary-defined terms, are to be interpreted in light of their contextual meaning in the relevant art.

Furthermore, the terms used in the embodiments of the invention are intended to describe the embodiments and are not intended to limit the invention.

In this specification, the singular may include the plural unless the context otherwise requires, and references to “at least one (or more) of A and (or) B and C” may include one or more of any combination of A, B, and C that may be assembled.

In addition, the terms first, second, A, B, (a), (b), and the like may be used to describe components of embodiments of the invention. Such terms are intended only to distinguish one component from another, and are not intended to limit the nature or sequence or order of such components by such terms.

Furthermore, when a component is described as “connected,” “coupled,” or “attached” to another component, it can include cases where the component is “connected,” “coupled,” or “attached” to the other component directly, as well as cases where the component is “connected,” “coupled,” or “attached” to another component that is between the component and the other component.

Furthermore, when described as being formed or disposed “above” or “below” each component, “above” or “below” includes not only when two components are in direct contact with each other, but also when one or more other components are formed or disposed between the two components. Furthermore, when expressed as “above” or “below”, it may include the meaning of upward as well as downward with respect to a single component.

Variations according to the present invention may include some configurations of each embodiment in combination with some configurations of other embodiments, i.e., a variation may include one embodiment of the various embodiments but omit some configurations and include some configurations of the corresponding other embodiments. Alternatively, the opposite may be true. The features, structures, effects, etc. described in the embodiments are included in at least one embodiment and are not necessarily limited to any one embodiment. Furthermore, the features, structures, effects, etc. exemplified in each embodiment may be combined or modified in other embodiments by one having ordinary knowledge in the field to which the embodiments belong. Accordingly, such combinations and variations should be construed as being within the scope of the embodiments.

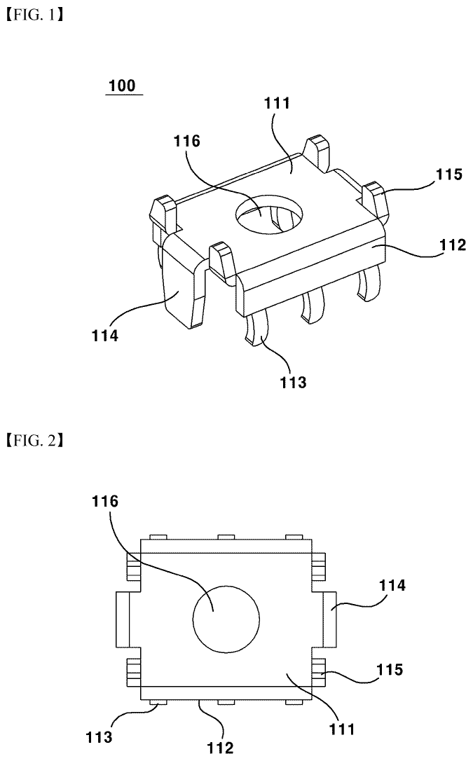

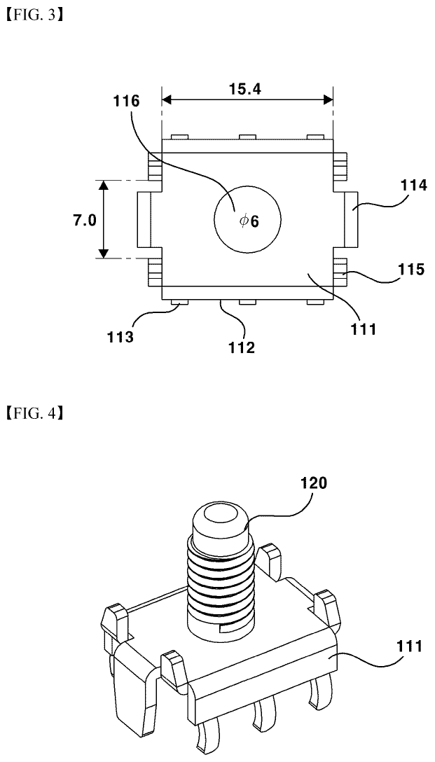

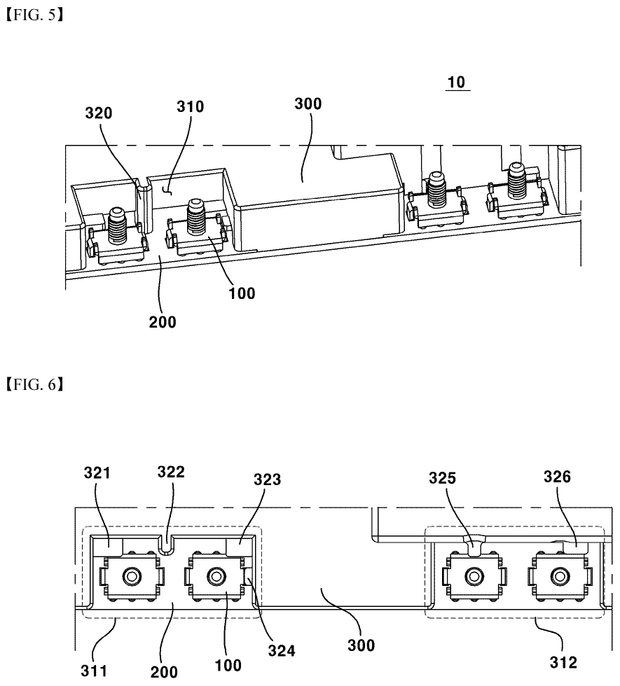

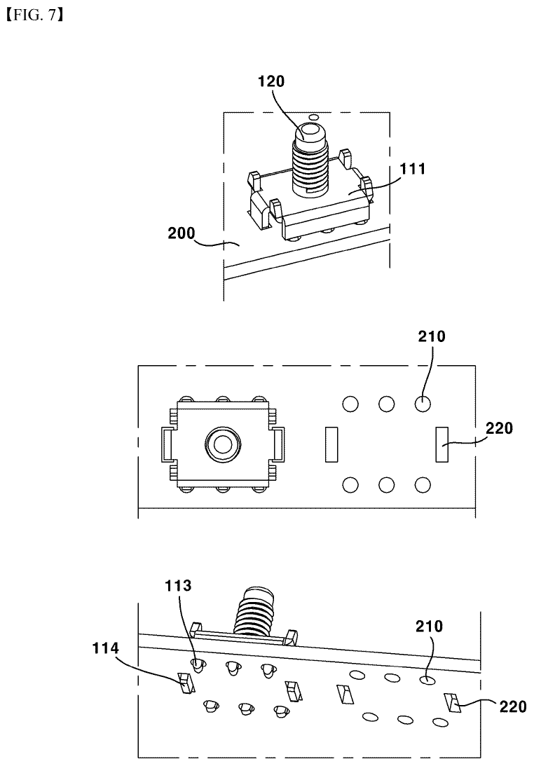

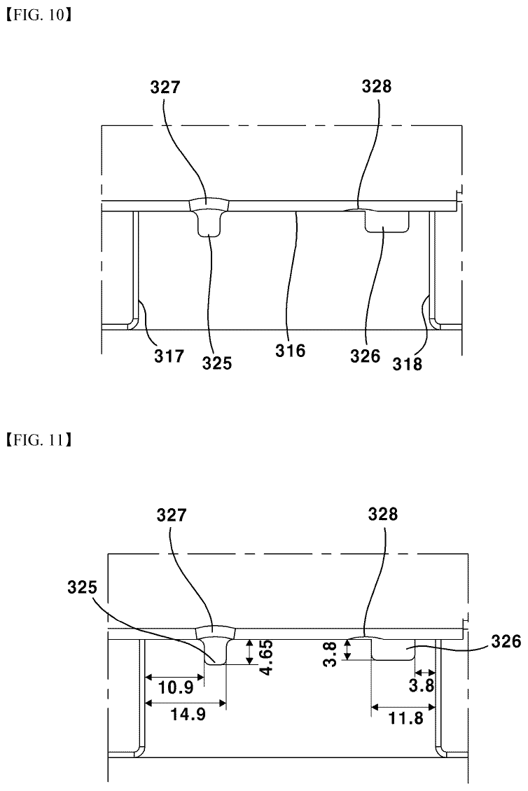

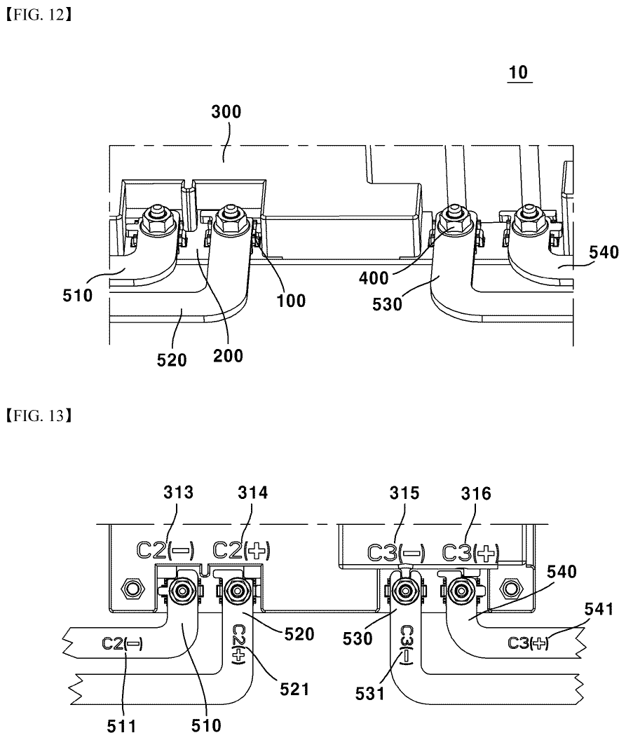

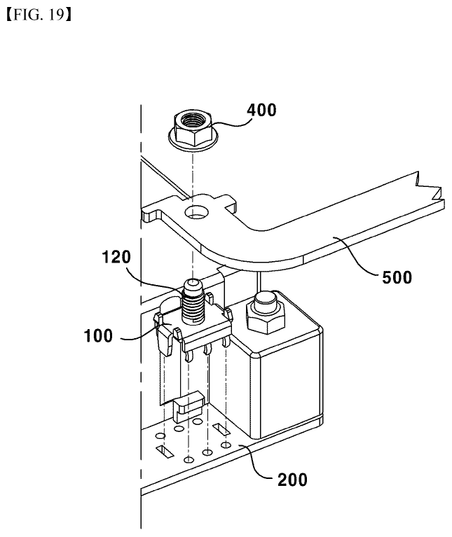

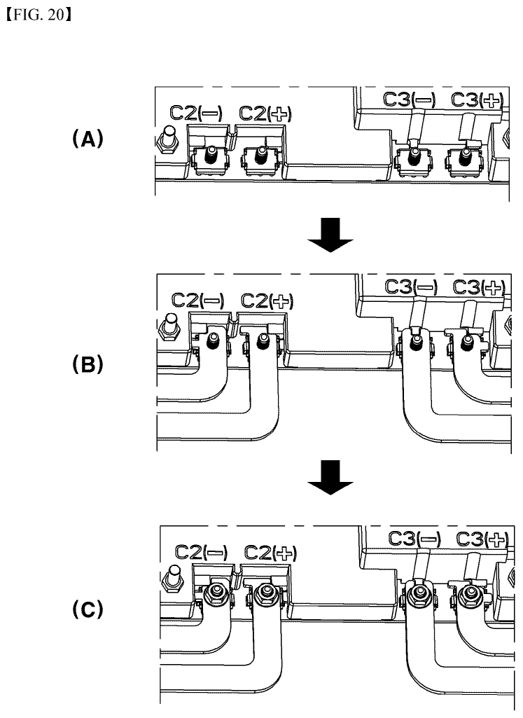

FIG. 1 is a perspective view of a connection terminal according to one exemplary embodiment of the present invention, FIG. 2 is a plan view of a connection terminal according to an exemplary embodiment of the present invention, FIG. 3 is a numerical example according to an exemplary embodiment of the present invention, FIG. 4 is a diagram of a screw connection part incorporated into a connection terminal according to an exemplary embodiment of the present invention, FIG. 5 is a perspective view of a connection terminal region of a power transmission device according to an exemplary embodiment of the present invention, FIGS. 6 to 11 are drawings to illustrate respective configurations of a connection terminal region of a power transmission device according to an exemplary embodiment of the present invention, FIG. 12 illustrates an example of a busbar being connected to the connection terminal region of a power transmission device according to an exemplary embodiment of the present invention, FIGS. 13 to 18 are drawings to illustrate the connected relationship of a busbar to a connection terminal region of a power transmission device according to an exemplary embodiment of the present invention, and FIGS. 19 and 20 are drawings illustrating an assembly process of a power transmission device and a busbar according to an exemplary embodiment of the present invention.

A connection terminal (100) according to one exemplary embodiment of the present invention may comprise a base (111), a first extension unit, a second extension unit, and a third extension unit, and may include a screw connection unit (120). The connection terminal (100) according to an embodiment of the present invention is a connection terminal that connects a substrate (200) and busbars (510 to 540), wherein the busbars (510 to 540) serve to electrically connect the substrate (200) to each other. The connection terminal may be electrically conductive conductors to electrically connect the substrate (200) and the busbars (510 to 540). It may be formed of metal or a variety of electrically conductive conductors. For example, it may be formed of copper.

The base (111) has a flat (plate) shape. On the base (111), the busbar to be connected may be positioned. The base (111) may have a rectangular shape or a shape corresponding to the shape of the busbar to be connected.

A first extension unit and a second extension unit extending downwardly from a lateral part of the base (111) are formed, and a third extension unit extending upwardly from the lateral part of the base (111) is formed. Here, the lower direction of the base (111) may be a direction in which it is connected to the substrate (200), and the upper direction may be a direction in which the busbars (510 to 540) are disposed.

The base (111) may be rectangular in shape and may have first to fourth lateral parts, i.e., four lateral parts. A first extension unit may extend downwardly from the first lateral part of the base (111) or from a second lateral part facing the first lateral part. The first extension unit may be formed in a shape corresponding to the first and second lateral parts, and may extend downwardly in a curved shape. The first extension unit may include a first lateral plate part (112) and a first protrusion (113). The first lateral plate part (112) may have a plate-like shape extending downwardly from the first lateral part or the second lateral part. The shape of the first lateral plate part (112) may be rectangular, and may be formed in a downward direction perpendicular to the base (111). The first lateral plate part (112) may be referred to as a first body part.

The first protrusion (113) may extend downwardly from the first plate part (112). The first protrusion (113) may include a plurality of first protrusions, each first protrusion (113) being spaced apart from the other. The first protrusion may have a protrusion shape, a pin shape, or a plate shape having a constant width. The first protrusion (113) may extend downwardly in a direction perpendicular to the base 111. Alternatively, the first protrusion 113 formed on the first or second lateral part may be curved to extend with a predetermined radius to the opposite lateral part, i.e. inwardly, or inclined at a predetermined angle. The first protrusion (113) may be elastic. The first lateral plate part (112) may be formed with a first lateral part at the first lateral part and a second lateral part. The first protrusion (113) may be formed with three first protrusions extending from each of the first plate parts (112), such that a total of six first protrusions may be formed.

The first protrusion (113) may serve as connecting pins that connect with the substrate (200), and can be inserted into holes formed on the substrate (200) to connect with the substrate (200). The first protrusion (113) may be electrically connected to the substrate (200), and may be joined to the substrate (200) via soldering.

The second extension unit may extend downwardly from a third lateral part of the base (111) or a fourth lateral part facing the third lateral part. The second extension unit may be formed in a shape corresponding to the third and fourth lateral parts located between the first and second lateral parts where the first extension unit is located, and may extend downwardly in a curved shape. The second extension unit may include a second protrusion (114) extending downwardly from the third lateral part or the fourth lateral part. The second protrusion (114) may have a plate-like shape, and may be formed in a downward direction perpendicular to the base (111). The second protrusion (114) may be shaped to have a width of a predetermined length, and may taper in width as it extends downwardly. It may include a first region that extends to a constant width and a second region that narrows in width. The second region that narrows in width may have a trapezoidal face shape. Here, the longitudinal direction is the extending direction and the width direction is a direction perpendicular to the longitudinal direction and parallel to the edge of each lateral part.

The second protrusion (114) may extend perpendicular to the base (111) in a downward direction from the base (111). Alternatively, the second protrusion (114) formed on the third or fourth lateral parts may be curved to have a predetermined radius or inclined at a predetermined angle to extend inwardly towards the opposite lateral part, i.e. inwardly. The second protrusion (114) may have a greater hardness than the first protrusion (113). To this end, the second protrusion (114) may have a longer widthwise length than the first protrusion (113). The second protrusion (114) may have one second protrusion formed on the third lateral part and one second protrusion formed on the fourth lateral part, so that a total of two second protrusions are formed.

The second protrusion (114) may be connected to the substrate (200) and may serve to prevent the connection terminal (100) from rotating. It may be formed to have a certain width to form a rigidity to prevent rotation, and may be engageable in a hole formed in the substrate (200). Alternatively, it may serve as a connecting pin that is electrically connected to the substrate (200) in addition to preventing rotation, and may be soldered to the substrate (200).

The third extension unit may extend upwardly from the third or fourth lateral part. The third extension unit may include a third protrusion (115) formed on the third or fourth lateral part to which the second extension extends downwardly, but located on either side of the second protrusion (114). The third protrusion (115) may have a plate-like shape and may be formed in an upward direction perpendicular to the base (111). The third protrusion (115) may be shaped to have a width of a predetermined length, and may taper in width as it extends upwardly. It may include a third region that extends to a constant width and a fourth region that narrows in width. It may also be formed with only the narrowing fourth region. The narrowing fourth region may have a trapezoidal face shape. Here, the longitudinal direction is the extending direction, and the width direction is a direction perpendicular to the longitudinal direction and parallel to the edges of each lateral part.

The second protrusion (114) may be formed with one in the center of the third or fourth lateral part, and the third protrusion (115) may be formed with two on either side of the single second protrusion (114), i.e. the central region of the third or fourth lateral part may extend downwards and the two edge regions may extend upwards. The third protrusion (115) may be formed with two third protrusions on each of the third and fourth lateral parts, such that a total of four third protrusions may be formed.

The third protrusion (115) may extend perpendicular to the base (111) in an upward direction of the base (111). The third protrusion (115) may have hardness greater than the first protrusion (113). To this end, the third protrusion (115) may have a longer widthwise length than the first protrusion (113). The widthwise length of the second protrusion (114) may be longer than the widthwise length of the third protrusion (115). The third protrusion (115) may be such that the sum of the width lengths of the two third protrusions formed on either side of the second protrusion (114) is equal to the width length of the second protrusion (114). Alternatively, the sum of the width lengths of the two third protrusions may be less than the width length of the second protrusion (114).

The third protrusion (115) may serve to prevent the busbars (510 to 540) from rotating when the busbars (510 to 540) are positioned on the base (111) by forming four contact points. The contacts may be formed to have a certain width to form a rigidity to prevent rotation, and may have a certain width to form an area abutting the lateral surfaces of the busbar. Here, the length between the third protrusions (115) formed on opposite sides and facing each other may correspond to the length of the busbars (510 to 540), i.e., the busbars (510 to 540) may be positioned between the four third protrusions (115) to prevent rotation in four directions. The busbars (510 to 540) may be interlocked in the space between the four third protrusions (115). The third protrusions (115) may be spaced apart from each other, and the four third protrusions may form four spaces to act as guides to ensure that the busbars (510 to 540) are positioned in the correct location according to the shape of the busbars (510 to 540).

The base (111), the first extension unit, the second extension unit, and the third extension unit may be formed integrally. It may be formed as a single plate, but may be formed by a bending process that bends each extension unit downwardly or upwardly.

The base (111) may include a hole (116) formed in the center, and a screw connection unit (120) having a threaded body protruding upwardly through the hole (116). When the busbars (510 to 540) are positioned on top of the base (111), they may be joined via a threaded (screw) connection. To this end, a hole (116) may be formed in the center of the base (111), through which the screw connection unit (120) having a screw thread for thread engagement with the busbars (510 to 540) may be threaded. The screw connection unit (120) may have the shape of a threaded, columnar bolt. The screw connection unit (120) may be inserted from a downward direction of the base (111) and may be engaged with the base (111) by means of a press-fit through a protrusion (jaw) that rests on the lower surface of the base (111), or by means of a threaded connection upon subsequent engagement with the busbars (510 to 540). Alternatively, it may be joined by welding. The screw connection unit (120) is inserted into and threaded into a hole in the busbar (510 to 540), which may serve to guide the busbar (510 to 540) into position on the base (111). After the busbars (510 to 540) are threaded through and positioned in the screw connection unit (120), the base (111), the screw connection unit (120), the busbars (510 to 540), and a nut (400) may be screwed together using the nut (400) to join the base (111), the screw connection unit (120), the busbars (510 to 540), and the nut (400). Pressure from the engagement of the screw connection unit (120) and the nut (400) may cause the base (111) and the busbars (510 to 540) to be contactively coupled and electrically connected.

The area of the top surface of the base (111) may vary depending on the current flowing through the connection terminal (100) and the allowable current density. When the substrate (200) and the busbars (510 to 540) are connected via the connection terminal (100), current flows, and for safety purposes, the base (111) must satisfy an allowable current density according to the flowing current, and the area of the top surface of the base (111) may be determined accordingly. For example, as shown in FIG. 3, the area of the top surface of the base may have a length of 15.4 mm on the first lateral part and a length of 7.0 mm between the two third protrusions (115) formed on the second lateral part. The thickness of the base (111) and each extension may be 1.2 mm.

As the first protrusion (113), as well as the second protrusion (114), is connected to the substrate (200) and the third protrusion (115) is joined to the busbars (510 to 540), it is possible to prevent rotation, so that a larger diameter bolt can be used as the screw connection unit (120) compared to the case of not having such an anti-rotation structure. In the case of not having an anti-rotation structure, an M4 nut with a tightening torque of 25 to 32 kgf·cm can be used, whereas an M6 nut with a tightening torque of 95 to 100 kgf·cm can be used. The hole (116) in the base (111) may be formed with a diameter of ø6 to correspond to the M6 nut. Furthermore, the height of the screw connection unit (120) may be determined by the thickness of the busbars (510 to 540) and the shape of the nut.

FIG. 5 is a perspective view of a connection terminal region of a power transmission device (10) according to one exemplary embodiment of the present invention. The power transmission device (10) according to one embodiment of the present invention may include a substrate (200), a housing (300), and a connection terminal (100). The power transmission device (10) according to an embodiment of the present invention may be a device in which the substrate (200) is connected to the outside to transmit power or receive power. In this case, the substrate (200) may be connected with busbars (510 to 540) on the outside, and the substrate (200) and busbars (510 to 540) may be connected via the connection terminal (100). The power transmission device (10) according to embodiments of the present invention may be a device that includes power connections to transfer or receive power, such as a DC-DC converter, an on board charger (OBC), a battery management system (BMS), or a device that incorporates two or more of these. Alternatively, the device that transmits or receives power may be a variety of power devices that require connection to a busbar.

The substrate (200) has a planar shape. The substrate (200) may be a printed circuit board (PCB). The substrate (200) may be a printed circuit board (PCB) or any other substrate electrically connected to the busbar. The housing (300) may cover the substrate (200), but may include a connection terminal region (310) where a portion of the substrate (200) is exposed and where connection terminals are disposed. The housing (300) may be formed of an insulating material. The housing (300) may be formed of, for example, PA66+GF25%, and the housing may have a thickness of 2.5 mm. Inside the housing (300), elements for converting or transmitting power may be disposed. The substrate exposed in the connection terminal region (310) may be a single sheet, but more than one substrate may be disposed in a stack inside the housing (300). The connection terminal region may be located outside the housing (300) rather than inside the housing (300), such that a portion of the substrate (200) is exposed to form the connection terminal region (310) so that the connection terminal (100) can be connected to the substrate (200). In the connection terminal region (310), the connection terminal (100) is formed and coupled to the substrate (200). Here, the detailed description of the connection terminal (100)) corresponds to the detailed description of the connection terminal (100) in FIGS. 1 to 4, and redundant descriptions will be omitted herein.

The connection terminal (100) may be coupled to the substrate (200) with a screw connection unit (120) coupled to the base (111). In this case, it may be coupled to the substrate (200) via a first extension unit and a second extension unit extending downwardly from the base (111). The first extension unit may be coupled via a plurality of first protrusions (113) on the first extension unit and second protrusions (114) on the second extension unit. The substrate (200) may include a plurality of first holes (210) corresponding to the first protrusions (113) and a plurality of second holes (220) corresponding to the second protrusions (114). The first holes (210) may be circularly shaped and the second holes (220) may be shaped to have a square cross-section.

In the first hole (210), a first protrusion (113) may be inserted and joined via soldering. In the first hole (210), a conductive line electrically connected to the elements disposed inside the housing (300) may be connected, and the conductive line and the first protrusion (113) may be electrically connected to the connection terminal (100) by soldering. To increase assemblability, the cross-sectional area of the first hole (210) may be larger than the cross-sectional area of the first protrusion (113). For example, it may have a 10% larger area. The first protrusion (113) may be inwardly curved or bevelled, and the connection terminal (100) may be secured to the substrate (200) prior to the soldering process when coupled to the first hole (210).

In the second hole (220), a second protrusion (114) may be inserted. The second protrusion (114) may be press-fit into the second hole (220) and may be joined via soldering. The second hole (220) may be formed in a square shape with a width direction of the second protrusion (114) wider than a thickness direction of the second protrusion (114) to fit the shape of the second protrusion (114), and may act to prevent the second protrusion (114) from rotating on the substrate (200) when the second protrusion (114) is engaged with the second hole (220) to prevent the connection terminal (100) from rotating on the substrate (200). The busbars (510 to 540) may be subjected to a force in the direction of rotation when engaged with the screw connection unit (120), which may result in rotation, which may result in tolerances. The combination of the second protrusion (114) and the second hole (220) can form a reinforcing structure that prevents rotation. To this end, the ratio of the cross-sectional area of the second hole (220) to the cross-sectional area of the second protrusion (114) may be formed smaller than the ratio of the cross-sectional area of the first hole (210) to the cross-sectional area of the second protrusion (114), i.e., only a ratio that takes into account the tolerance may be applied. For example, they may have an area that is 1 to 2% larger.

After the first protrusion (113) and the second protrusion (114) are inserted into the first hole (210) and the second hole (220), respectively, the substrate (200) and the connection terminal (100) are electrically connected via soldering.

The connection terminal region (310) may include a plurality of connection terminal regions (311, 312), and the plurality of connection terminal regions may each have a differently shaped protrusions (320) formed thereon. The plurality of connection terminal regions (311, 312) may be formed with different shapes of protrusions (320), and the plurality of connection terminal regions (311, 312) may be matched and connected with busbars (510 to 540) corresponding to the protrusions (320), respectively. Each connection terminal region (310) may have different busbars (510 to 540) to which it is to be connected, and each may have a different shape such that the corresponding busbars (510 to 540) have a one-to-one correspondence.

The connection terminal region (310) may include a first lateral surface (313) spaced inwardly from an edge of one lateral part of the substrate (200), and second lateral surface (314) and third lateral surface (315) extending from both sides of the first lateral surface (313) towards the edge of the one lateral part of the substrate (200), wherein the first recess formed by the substrate (200), the first lateral surface (313), the second lateral surface (314), and the third lateral surface (315) may be open in an upward direction of the substrate (200) and in a direction outward of an edge of the one lateral part of the substrate (200). In order to protect the elements formed on the substrate with the housing (300), but to facilitate the process of coupling the connection terminal (100) to the substrate (200), or coupling the busbars (510 to 540) to the connection terminal (100), the connection terminal region forms a first recess exposed to an area outside the housing (300). The first recess may be formed by being open in an upward direction of the substrate (200) and outward of an edge of one lateral part of the substrate (200). The closed lateral surface may include a first lateral surface (313) in an inward direction and a second lateral surface (314) and a third lateral surface (315) extending from both sides of the first lateral surface (313) in the direction of the edge of the one lateral part of the substrate (200).

The protrusion (320) may be formed by protruding from at least one of the first lateral surface (313), the second lateral surface (314), and the third lateral surface (315). By having different shapes of the protrusions (320), the spaces formed by the protrusions (320) can be different from each other, and misassembly of the busbars can be prevented by ensuring that busbars other than those having a shape corresponding to the space cannot be fitted into the space. Large currents may flow through the busbars (510 to 540) connecting the connection terminal (100), and misassembly may cause burnout of the elements inside the power transmission device (10) or failure of other devices connected via the busbars (510 to 540). By preventing misassembly of the busbars (510 to 540) via the protrusions (320), a poka-yoke can be implemented, which can improve assembly and reliability.

The connection terminals may be formed by paired (+) and (−) terminals. Within the first recess, there may be a first connection terminal and a second connection terminal that are paired with each other to form a (+) terminal and a (−) terminal. The first and second connection terminals may have the same shape as each other.

The connection terminal region (311) may include a first protrusion 321 protruding in the direction of the first connection terminal from a corner formed by the first lateral surface (313) and the second lateral surface (314), and a second protrusion (322) protruding in the direction between the first connection terminal and the second connection terminal from a center of the first lateral surface (313), a third protrusion (323) protruding in the direction of the second connection terminal from a corner formed by the first lateral surface (313) and the third lateral surface (315), and a fourth protrusion (324) protruding in the direction of the second connection terminal from the third lateral surface (315).

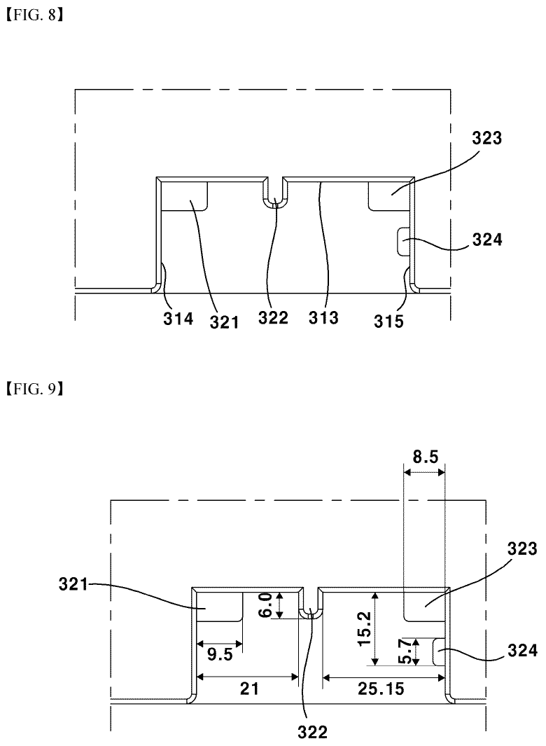

A first protrusion (321) may protrude from a corner of the first lateral surface (313) and the second lateral surface (314), and a second protrusion (322) may protrude from the first lateral surface (313) to form a space corresponding to the busbar (510) to be located in the area where the first connection terminal is located. The first protrusion may have a rectangular shape, as shown in FIG. 8, when viewed from above, wherein the rectangular shape may have one side abutting the first lateral surface (313) and the other side abutting the second lateral surface (314). The second protrusion (322) may protrude from the first lateral surface (313) in a protruding shape, but may be biased towards the first connection terminal side. The first protrusion (321) and second protrusion (322) may form a space corresponding to the busbar (510) connected to the first connection terminal. The second protrusion (322) may affect the busbar (510) connecting to the first connection terminal but not affect the busbar (520)) connecting to the second connection terminal. The third protrusion (323) may have a square shape, as shown in FIG. 8, when viewed from above, wherein the square shape may have one side abutting the first lateral surface (313) and the other side abutting the third lateral surface (315). A fourth protrusion (324) may protrude squarely from the third lateral surface (315). The third protrusion (323) and the fourth protrusion (324) may form a space corresponding to the busbar (520) connected to the second connection terminal.

Here, the shape of the first to fourth protrusions forming each space may be implemented as shown in FIG. 9. The overall housing may have dimensions of 490×210×35 mm. The first protrusion (321) may have a length of 9.5 mm abutting the first lateral surface (313) and a length of 6.0 mm abutting the second lateral surface (314). The second protrusion (322) may protrude 6.0 mm from the first lateral surface (313), but may be spaced 21 mm from the second lateral surface (314) and 25.15 mm from the third lateral surface (315), and may be formed biased towards the second lateral surface (314). The third protrusion (323) may have a length of 8.5 mm abutting the first lateral surface (313) and a length of 6.0 mm abutting the second lateral surface (314). The fourth protrusion (324) may protrudeject from the third lateral surface (315) with a width of 5.7 mm, but the distance from the first lateral surface (313) to the outermost side may be 15.2 mm.

The connection terminal may be two or more than four mated to each other, wherein the connection terminal may include a third connection terminal and a fourth connection terminal mated to each other to form a (+) terminal and a (−) terminal, the connection terminal area (312) wherein the third connection terminal and the fourth connection terminal are located, may include a fifth protrusion (325) protruding from a first lateral surface (316) towards the center of the third connection terminal and a sixth protrusion (326) protruding from the first lateral surface (316) towards the fourth connection terminal, but biased towards the third lateral surface (318).

The distance that the first lateral surface (316) of the connection terminal region (312) on which the third and fourth connection terminals are located is spaced apart from the edge of the substrate (200) may be shorter than the distance that the first lateral surface (313) of the connection terminal region (311) on which the first and second connection terminals are located is spaced apart from the edge of the substrate (200). In this case, the short distance between the first lateral surface (316) and the connection terminal (100) may make it difficult to turn a nut (400) when mating the busbars, so the first lateral surface (316) may have one or more recesses (327, 328) formed in it to provide assembly space. The recesses (327, 328) may be inwardly recessed in the housing and may be recessed along a circular shape to accommodate rotation of the nut. A distance that a first lateral surface (316) of the connection terminal region (312) where the third and fourth connection terminals are located is spaced apart from an edge of the substrate (200) may be the same as a distance that a first lateral surface (313) of the connection terminal region (311) where the first and second connection terminals are located is spaced apart from an edge of the substrate (200), and recesses (327, 328) may not be formed.

In contrast to the first protrusion (321) and third protrusion (323) protruding from the corner in the connection terminal region (311) where the first and second connection terminals are located, the connection terminal region (312) where the third and fourth connection terminals are located may not have protrusions protruding from the corner, but may have a fifth protrusion (325) and a sixth protrusion (326) protruding from the first lateral surface (316) in the direction of the third and fourth connection terminals, respectively. The second lateral surface (317) and third lateral surface (318) may not be formed with any protrusions. Here, the fifth protrusion (325) may protrude from a position corresponding to the center of the hole of the third connection terminal, and the sixth protrusion (326) may protrude from a position corresponding to the center of the hole of the fourth connection terminal, biased towards the third lateral surface (318). Furthermore, different spaces can be formed by forming the width of the sixth protrusion (326) wider than the width of the fifth protrusion (325).

Here, the shapes of the fifth protrusion (325) and sixth protrusion (326) forming each space may be implemented as shown in FIG. 11. The fifth protrusion (325) may protrude 4.65 14 mm from the first lateral surface (316), but may be spaced 10.9 mm from the second lateral surface (317), and may be 4.0 mm wide. The sixth protrusion (326) may protrude 3.8 mm from the first lateral surface (316), but may be spaced 3.8 mm from the third lateral surface (318), and may be 8.0 mm wide.

The power transmission device (10) according to an exemplary embodiment of the present invention has connection terminal (100) that is coupled with the substrate (200) in connection terminal regions formed on the housing (300), as shown in FIG. 12, and connect with the busbars (510 to 540) via nuts (400). To improve assemblability, identifying information for each terminal to be assembled may be stamped (313 to 316) on the housing (300) proximate to each connection terminal region, as shown in FIG. 13. In addition, the busbars (510 to 540) can be stamped (511 to 541) with respective identification information. The connection terminals may include paired C2(−), C2(+) and C2(−), C2(+), respectively. Here, C2(−), C2(+) may be connection terminals in connection with a battery, and C2(−), C2(+) may be connection terminals in connection with other device accessories. Due to the large current flowing through the busbars, each set of busbars may be spaced apart so that they do not affect each other. For example, they may be spaced apart by 200 mm or more. In addition, the connection directions of the busbars may be arranged so that they do not overlap and face in opposite directions. Each busbar has a different shape and is matched and mated to a connection terminal region that forms a corresponding space. The busbars cannot be assembled in mismatched terminal areas due to their different spaces, thus preventing misassembly.

Each busbar may be composed of copper, and may be 15 mm wide and 3t thick. The shape of each busbar located in the connection terminal region may be different, but the area of the corresponding region of each busbar may be the same. Alternatively, they may be shaped to have more than the required area depending on the allowable current density.

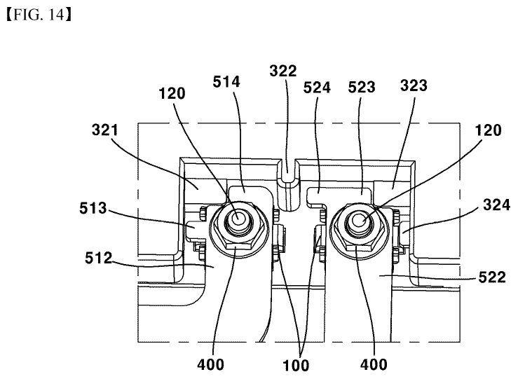

The connection terminal regions (311) connecting C2(−), C2(+) may be connected to each of the busbars (510, 520), as shown in FIG. 14. The first busbar (510) is coupled to the screw connection unit (120) of the connection terminal (100) via the nut (400), wherein a body region (512) of the first busbar (510) abuts the four third protrusions (115) of the connection terminal (100) to prevent rotation due to rotational coupling torque. Further, the first protrusion (113) of the connection terminal (100) can prevent rotation of the substrate (200) and the connection terminal (100) by the first protrusion (113) of the connection terminal (100). This can improve the stability of the assembly. The first busbar (510) may include a first protrusion region (513) and a second protrusion region (514) that protrude from the body region (512) to correspond to the shape of the space formed by the first protrusion (321) and the second protrusion (322). That is, the first protrusion region (513) of the first busbar (510) is positioned between the second protrusion of the connection terminal (100), and the second protrusion region (514) of the first busbar (510) abuts the first protrusion (321) such that it can be coupled to the space formed by the first protrusion (321) and the second protrusion (322) corresponding to the space in the corresponding connection terminal region.

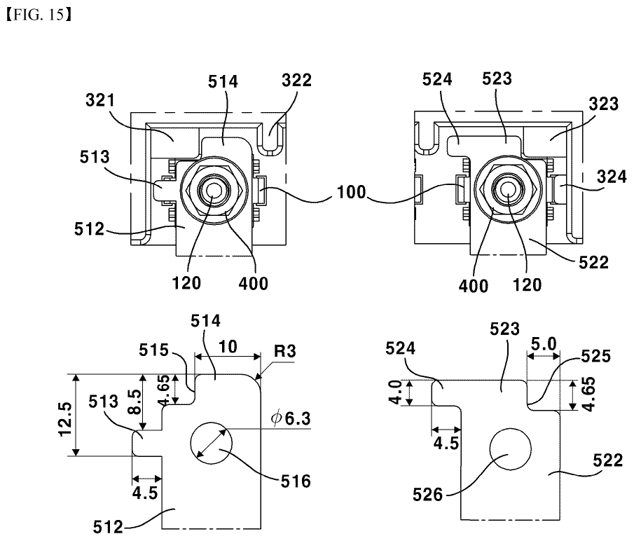

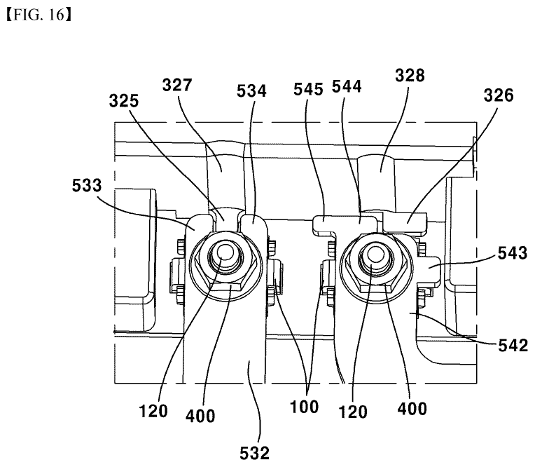

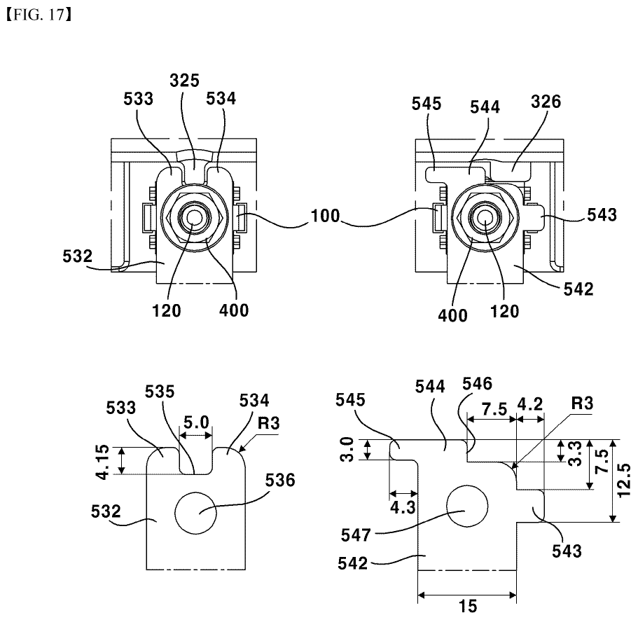

The first busbar (510) may be implemented as shown in FIG. 15. The first busbar (510) may have a hole (516) of Ø6.3 formed in the body region (512) through which the screw connection unit (120) of the connection terminal (100) passes. The first protruding region (513) is formed by protruding from the body region (512) in a direction perpendicular to the longitudinal direction, and may have a shape that allows it to be disposed in a region between the second protrusions (114) of the connection terminal (100). The first protrusion region (513) may be formed to protrude 4.5 mm from the body region (512) and have a width of 4.0 mm. The second protrusion region (514) may protrude 4.65 mm from the body region (512), may be formed to have a width of 10 mm, and may be rounded with a radius of R3 in the direction of the second protrusion (322). Opposite the roundness of the second protrusion region (514), a recess (515) may be formed to correspond to the first protrusion (321). That is, the first protrusion region (513) is positioned between the second protrusion (114) of the connection terminal (100), and the second protrusion region (514) is positioned between the first protrusion (321) and the second protrusion (322), but the first protrusion (321) is positioned in the first recess (515) so that the first busbar (510) can be coupled to that space without interference.

The second busbar (520) is coupled to the screw connection unit (120) of the connection terminal (100) via the nut (400), wherein a body region (522) of the second busbar (520) abuts the four third protrusions (115) of the connection terminal (100) to prevent rotation due to rotational coupling torque. Furthermore, the first protrusion (113) of the connection terminal (100) can prevent rotation of the substrate (200) and the connection terminal (100) by the first protrusion (113) of the connection terminal (100). This can improve the stability of the assembly. The second busbar (520) may include a third protrusion (523) and a fourth protrusion (524) that protrude from the body region (522) to correspond to the shape of the space formed by the second protrusion (322) and the third protrusion (323). The third protrusion region (523) of the second busbar (520) abuts the third protrusion (323) and does not form a protrusion in the direction in which the fourth protrusion (324) protrudes, a fourth protrusion region (524) protrudes from the third protrusion region (523) toward the second protrusion (322), and may be coupled to the space formed by the second protrusion (322), the third protrusion (323), and the fourth protrusion (324), corresponding to the space in the corresponding connection terminal region.

The second busbar (520) may be implemented as shown in FIG. 15. The second busbar (520) may have a hole 526 of Ø6.3 formed in a body region (522) through which the screw connection unit (120) of the connection terminal (100) passes. A third protrusion region (523) may be formed by protruding in a longitudinal direction from the body region (522), and a fourth protrusion region (524) may be formed by protruding in a direction perpendicular to the longitudinal direction of the second busbar (520) from the third protrusion region (523). The third protrusion region (523) may be formed by protruding 4.65 mm from the body region (522). The fourth protrusion region (524) may protrude 4.5 mm from the third protrusion region (523) and may be formed with a width of 4.0 mm. On the side opposite to where the fourth protrusion region (524) is formed, a second recess (525) may be formed to correspond to the third protrusion (323). In other words, the third protrusion region (523) and the fourth protrusion region (524) are located between the second and third protrusions (322 and 323), but the third protrusion (323) is located in the second recess (525), and no protrusion region is formed in the position corresponding to the fourth protrusion (324), so that the second busbar (520) can be coupled to that space without interference.

The connection terminal regions (312) connecting with C3 (−), C3 (+) may be connected with respective busbars (530, 540), as shown in FIG. 16. The third busbar (530) is coupled to the screw connection unit (120) of the connection terminal (100) via the nut (400), wherein the body region (532) of the third busbar (530) abuts the four third protrusions (115) of the connection terminal (100) to prevent rotation due to rotational coupling torque. Furthermore, the first protrusion (113) of the connection terminal (100) may prevent rotation of the substrate (200) and the connection terminal (100) by the first protrusion (113) of the connection terminal (100). This can improve the stability of the assembly. The third busbar (530) may include a fifth protrusion region (533) and a sixth protrusion region (534) that protrude from the body region (532) to correspond to the shape of the space formed by the fifth protrusion (325). In other words, the fifth protrusion region (533) and the sixth protrusion region (534) of the third busbar (530) may be spaced apart from each other, with the fifth protrusion (325) positioned therebetween to correspond to the space of the corresponding connection terminal region and to be coupled to the space formed by the fifth protrusion (325).

The third busbar (530) may be implemented as shown in FIG. 17. The third busbar (530) may have a hole 536 of ø6.3 formed in the body region (532) through which the screw connection unit (120) of the connection terminal (100) passes. The fifth protrusion region (533) and the sixth protrusion region (534) are formed by protruding 4.15 mm longitudinally from the body region (532), spaced 5.0 mm apart from each other, and a third recess (535), which is the space between the fifth protrusion region (533) and the sixth protrusion region (534), may be abutted by the fifth protrusion (325). The fifth protrusion region (533) and the sixth protrusion region (534) may be formed in a round shape with a radius of R3 on the outer side opposite the inner side abutting the fifth protrusion (325), i.e., the space between the fifth protrusion region (533) and the sixth protrusion region (534) may be provided with the fifth protrusion (325) so that the third busbar (530) may be coupled to that space without interference.

The fourth busbar (540) is coupled to the screw connection unit (120) of the connection terminal (100) via the nut (400), wherein the body region (542) of the fourth busbar (540) abuts the four third protrusions (115) of the connection terminal (100) to prevent rotation due to rotational coupling torque. Furthermore, the first protrusion (113) of the connection terminal (100) can prevent rotation of the substrate (200) and the connection terminal (100) by the first protrusion (113) of the connection terminal (100). This can improve the stability of the assembly.

The fourth busbar (540) may include a seventh protrusion region (543), an eighth protrusion region (544), and a ninth protrusion region (545) that protrude from the body region (542) to correspond to the shape of the space formed by the sixth protrusion (326). That is, the seventh protrusion region (543) of the fourth busbar (540) may be located between the second protrusions of the connection terminal (100), and the eighth protrusion region (544) of the fourth busbar (540) may abut the sixth protrusion (326), a ninth protrusion region (545) may protrude from the eighth protrusion region (544) in the opposite direction of the sixth protrusion (326), and may be coupled to the space formed by the sixth protrusion (326), corresponding to the space in the corresponding connection terminal region.

The fourth busbar (540) may be implemented as shown in FIG. 17. The fourth busbar (540) may have a hole (547) ø6.3 formed in the body region (542) through which the screw connection unit (120) of the connection terminal (100) passes. The seventh protrusion region (543) is formed by protruding from the body region (542) in a direction perpendicular to the longitudinal direction, and may have a shape that allows it to be disposed in the region between the second protrusions (114) of the connection terminal (100). The seventh protrusion region (543) may be formed to protrude 4.2 mm from the body region (542) and have a width of 5.0 mm. An eighth protrusion region (544) may protrude 3.3 mm from the body region (542), and a ninth protrusion region (545) may be formed by protruding from the eighth protrusion region (544) in a direction perpendicular to a longitudinal direction of the fourth busbar (540). The ninth protrusion region (545) may protrude 4.3 mm from the eighth protrusion region (544) and may be formed with a width of 3.0 mm. On the opposite side where the ninth protrusion region (545) is formed, a fourth recess (546) may be formed to correspond to the sixth protrusion (326), such that the sixth protrusion (326) is located in the fourth recess (546) so that the fourth busbar (540) can be coupled to that space without interference.

As described above, differently shaped recesses are formed in the connection terminal regions, and the shape of the busbar is shaped to correspond to the space formed by each recess, but each busbar can be interference-free coupled only to the space it corresponds to, and not to other spaces, thereby preventing misassembly.

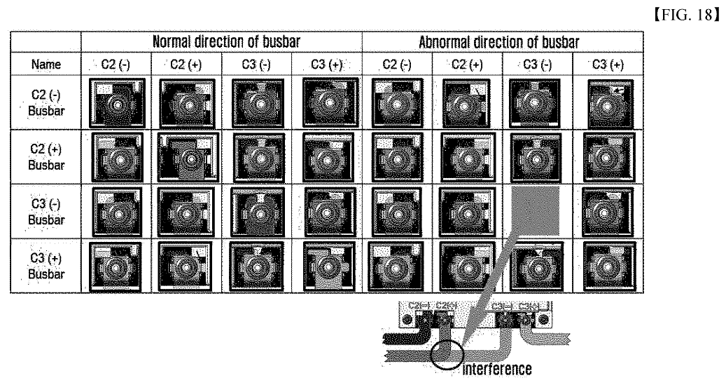

FIG. 18 shows the interference of each connection terminal and each busbar, and it can be seen that there is no interference between the corresponding connection terminal regions and busbars, but interference occurs between the non-corresponding connection terminal regions and busbars. It can be seen that interference occurs not only in the normal direction of the busbar where the top and bottom of the busbar are not reversed, but also in the abnormal direction of the busbar where the top and bottom of the busbar are reversed. It is possible to install the C3 (−) busbar inverted on the C3 (−) connection terminal, but interference with the C2 (+) busbar will occur, so misassembly can be prevented.

As described above, rotation can be prevented by forming the connection terminal, and misassembly of the busbar can be prevented by forming the connection terminal region and the busbar to correspond to each other, thus enabling poka-yoke. This improves workability and reliability.

The assembly of the power transmission device (10) and the busbar (500) may include the substrate (200), the connection terminal (100), the screw connection unit (120) of the connection terminal (100), the busbar (500), and the nut (400) in sequence, as shown in FIG. 19. In this case, the power transmission device (10) and the busbar (500) can be assembled in the sequence shown in FIG. 20, and misassembly can be prevented in the process.

First, connect the connection terminal to the connection terminal regions, as shown in FIG. 20(A). The connection terminals and the substrate can be electrically connected by soldering them together. Then, as shown in FIG. 20(B), a busbar is positioned between the screw connection unit of the connection terminal and the second protrusion. In this case, the busbars corresponding to each connection terminal region are different, and the busbars not corresponding to the corresponding position cannot be assembled to prevent misassembly by the operator. Then, as shown in FIG. 20(C), a nut is rotationally screwed onto the screw connection unit to make the busbar contact the connection terminal to electrically connect the substrate and the busbar through the connection terminal. Engaging the nut generates a rotational torque, which can be prevented from rotating through the second and third protrusions of the connection terminal into their respective courts.

One of ordinary skill in the art to which the present embodiments relate will understand that they may be implemented in modified form without departing from the essential features of the above described materials. The disclosed methods are therefore to be considered from an illustrative and not a limiting point of view. The scope of the invention is shown in the claims of the patent and not in the foregoing description, and all differences within that scope are to be construed as being included in the invention.

1.-10. (canceled)

11. A connection terminal comprising:
a base;
a first extension unit extending downward from a lateral part of the base;
a second extension unit extending downward from a lateral part of the base; and
a third extension unit extending upward from a lateral part of the base.

12. The connection terminal of claim 11, wherein the base is rectangular in shape, and
wherein the first extension unit extends downwardly from a first lateral part of the base or a second lateral part of the base facing the first lateral part.

13. The connection terminal of claim 12, wherein the first extension unit comprises:
a first lateral plate part extending downwardly from the first lateral part or the second lateral part; and
a plurality of first protrusions extending downwardly from the first lateral plate part and spaced apart from each other.

14. The connection terminal of claim 11, wherein the base is rectangular in shape, and
wherein the second extension unit extends downwardly from a third lateral part of the base or a fourth lateral part of the base facing the third lateral part.

15. The connection terminal of claim 14, wherein the second extension unit comprises a second protrusion extending downwardly from the third lateral part or the fourth lateral part.

16. The connection terminal of claim 15, wherein the third extension unit comprises a plurality of third protrusions extending upwardly from the third lateral part or the fourth lateral part, and disposed on either side of the second protrusion.

17. The connection terminal of claim 16, wherein the second protrusion is disposed at a center of the third lateral part or the fourth lateral part, and wherein the plurality of third protrusions comprises two third protrusions disposed at either side of the second protrusion.

18. The connection terminal of claim 16, wherein a widthwise length of the second protrusion is longer than a widthwise length of one of the plurality of third protrusions.

19. The connection terminal of claim 11, further comprising a screw coupling unit comprising a body formed with threads and protruding upwardly through a hole which is formed at a center of the base.

20. The connection terminal of claim 11, wherein a size of an area of an upper surface of the base varies depending on a current flowing through the connection terminal and an allowable current density.

21. A power transmission device comprising:
a substrate;
a housing covering the substrate and comprising a plurality of connection terminal regions in which a portion of the substrate is exposed and in which a connection terminal is disposed; and
the connection terminal disposed in the connection terminal regions,
wherein each of the plurality of connection terminal regions is formed with mutually differently shaped protrusions.

22. The power transmission device of claim 21, wherein each of the plurality of connection terminal regions is matched and connected with a busbar corresponding to the protrusion.

23. The power transmission device of claim 21, wherein the connection terminal region comprises:
a first lateral surface spaced apart inwardly from an edge of one lateral part of the substrate; and
a second lateral surface and a third lateral surface extending from both sides of the first lateral surface in a direction of the edge of the one lateral part of the substrate,
wherein a first recess formed by the substrate, the first lateral surface, the second lateral surface, and the third lateral surface is open in an upward direction of the substrate and an outward direction of the edge of the one lateral part of the substrate, and
wherein the protrusion protrudes from at least one of the first lateral surface, the second lateral surface, and the third lateral surface.

24. The power transmission device of claim 23, wherein a first connection terminal and a second connection terminal which are paired with each other to form a (+) terminal and a (−) terminal are disposed at the first recess, and
wherein the connection terminal region comprises:
a first protrusion protruding in a direction to the first connection terminal from a corner formed by the first lateral surface and the second lateral surface;
a second protrusion protruding from a center of the first lateral surface in a direction between the first connection terminal and the second connection terminal;
a third protrusion protruding in a direction to the second connection terminal from a corner formed by the first lateral surface and the second lateral surface; and
a fourth protrusion protruding from the third lateral surface in a direction to the second connection terminal.

25. The power transmission device of claim 23, wherein a third connection terminal and a fourth connection terminal, which are paired with each other to form a (+) terminal and a (−) terminal are disposed at the first recess, and
wherein the connection terminal region comprises:
a fifth protrusion protruding in a direction to towards a center of the third connection terminal from the first lateral surface; and
a sixth protrusion protruding from the first lateral surface in a direction to the fourth connection terminal, and biased towards the third lateral surface.

26. The power transmission device of claim 21, wherein the connection terminal comprises:
a base;
a first extension unit extending downward from a lateral part of the base;
a second extension unit extending downward from a lateral part of the base; and
a third extension unit extending upward from a lateral part of the base.

27. The power transmission device of claim 26, wherein the first extension unit extends downwardly from a first lateral part of the base or a second lateral part of the base facing the first lateral part.

28. The power transmission device of claim 27, wherein the first extension unit comprises:
a first lateral plate part extending downwardly from the first lateral part or the second lateral part; and
a plurality of first protrusions extending downwardly from the first lateral plate part and spaced apart from each other.

29. The power transmission device of claim 26, wherein the second extension unit extends downwardly from a third lateral part of the base or a fourth lateral part of the base facing the third lateral part.

30. The power transmission device of claim 29, wherein the second extension unit comprises a second protrusion extending downwardly from the third lateral part or the fourth lateral part, and
wherein the third extension unit comprises a plurality of third protrusions extending upwardly from the third lateral part or the fourth lateral part, and disposed on either side of the second protrusion.
